(19) United States
(12) Patent Application Publication
(10) Pub. No.: US 2018/0322248 A1
(43) Pub. Date: Nov. 8, 2018

(54) MOBILE INTEROPERABLE PERSONAL HEALTH INFORMATION EXCHANGE WITH BIOMETRICS DATA ANALYTICS

(71) Applicant: CORAnet Solutions, Inc., Washington, DC (US)

(72) Inventor: Cora Alisuag, Washington, DC (US)

(73) Assignee: CORAnet Solutions, Inc.

(21) Appl. No.: 15/584,087

(22) Filed: May 2, 2017

(51) Int. Cl. G06F 19/00

(52) U.S. Cl. CPC G06F 19/322

(57) ABSTRACT

A mobile interoperable personal health information exchange with biometrics data analytics comprising a cloud platform implementing an aggregation service, a storage service, a formatting service and an analysis and alert notification service, the aggregation service periodically collecting electronic health records from a plurality of third party medical record providers specific to an individual user, the storage service only temporarily storing in a database the collected electronic medical records, the formatting service generating an aggregated medical file specific to the individual user comprising all the temporarily stored electronic medical records for that individual user and the analysis and alert notification service analyzing data included within the aggregated medical file to possibly identify health related abnormalities with the individual user.

### FIELD OF THE INVENTION

This disclosure relates generally to a patient facing mobile interoperable personal health information exchange with real-time biometric data and medical health analytics.

### BACKGROUND

Immediate access to a patient's full, up-to-date actionable medical history is imperative in emergency and urgent care, including when the patient is unconscious, and essential to routine and maintenance healthcare. This information must be coordinated in order to reduce the costs of poor outcomes, medical errors, higher malpractice premiums, and penalties for non-compliance with federal mandates. Despite recent advances, there is no unification across paper records and the multitude of electronic medical health record systems in use today, both mobile and web-based. What is needed is a platform that seamlessly integrates all of a patient's electronic personal health records from disparate systems as well as the patient's real-time biometric health data available from a plurality of wearable medical device.

Information exchanges presently lack interoperability since electronic health record providers are reticent to share their proprietary data in these exchanges, these electronic health record providers including hospitals, outpatient clinics, health insurance agencies, physician practices, and prescription drug providers. What is further needed is a platform that allows the patient to aggregate their medical records originating from a plurality of health record providers in a secure manner such that when the plurality of medical records have been retrieved and aggregated they are kept and stored solely by the patient alone and not by the platform. What is needed is a platform that provides for vertical integration of a patient's personal medical health records across a plurality of health record providers in a manner that allows the personal medical health records providers to keep their proprietary medical information secure.

### BRIEF SUMMARY

In an attempt to provide for the above-described needs a mobile interoperable personal health information exchange is presented with biometrics data analytics comprising a cloud platform implementing an aggregation service, a storage service, a formatting service and an analysis and alert notification service, the aggregation service periodically collecting electronic health records from a plurality of third party medical record providers specific to an individual user, the storage service temporarily storing in a database the collected electronic medical records for processing by the formatting and the analysis and alert notification services and subsequently erasing all non-anonymized medical records from the database without providing subsequent access to all non-anonymized medical records, the formatting service generating an aggregated medical file specific to the individual user comprising all the temporarily stored electronic medical records for that individual user, and the analysis and alert notification service analyzing data included within the aggregated medical file to possibly identify health related abnormalities with the individual user.

### BRIEF DESCRIPTION OF THE DRAWINGS

This disclosure is further described in the detailed description that follows, with reference to the drawings, in which:

FIG. 1 is a high-level overview of a mobile interoperable personal health information exchange with biometrics data analytics according to an exemplary embodiment.

FIG. 2 is a block diagram of an exemplary cloud platform implementing the mobile interoperable personal health information exchange with biometrics data analytics.

FIG. 3 is a flow diagram depicting a process implemented on the cloud platform of the mobile interoperable personal health information exchange with biometrics data analytics according to an exemplary embodiment.

FIG. 4 is a flow diagram depicting a process implemented in a remote smartphone type device communicating with the mobile interoperable personal health information exchange with biometrics data analytics according to an exemplary embodiment.

FIG. 5 is a flow diagram depicting the analysis of real-time biometric data on the cloud platform of the mobile interoperable personal health information exchange with biometrics data analytics according to an exemplary embodiment.

### DETAILED DESCRIPTION

An exemplary embodiment of a patient facing mobile interoperable personal health information exchange with biometrics data analytics is disclosed. As required, detailed embodiments of the present invention are disclosed herein, however, it is to be understood that the disclosed embodiments are merely exemplary of the invention that may be embodied in various and alternative forms. The structural and functional details disclosed herein are not to be interpreted as limiting, but merely as a representative basis for teaching one skilled in the art to variously employ the present invention.

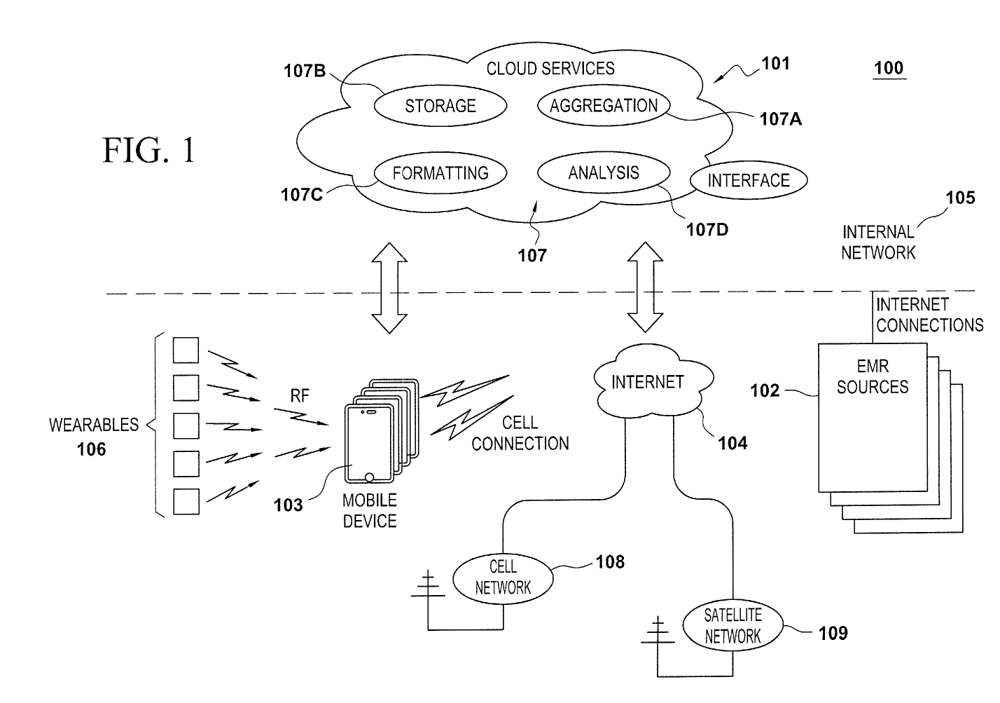

In FIG. 1, a high-level overview of a mobile interoperable personal health information exchange with biometrics data analytics according to an exemplary embodiment is shown. As shown in FIG. 1, the mobile interoperable personal health information exchange with biometrics data analytics 100 includes a cloud platform 101 communicating with a plurality of electronic health record providers 102 and a plurality of mobile and medical devices 103. The cloud platform 101 communicates with the plurality of electronic health record providers 102 over a wide area network 104 connection that may include the Internet or any other public or private wide area network known to one skilled in the art. The cloud platform 101 communicates with the plurality of wireless mobile devices and medical devices 103 over a cellular network connection 108 or any other wireless network connection known to one skilled in the art. The cloud platform 101 may also communicate with the plurality of wireless devices 103 over a satellite network connection 109 if a wireless device 103 is satellite capable.

A Software as a Service (SaaS) model implemented on the cloud platform 101 delivers several cloud computing services 107 that enable the implementation of the mobile interoperable personal health information exchange with biometrics data analytics 100. These cloud based SaaS services 107 include, but are not limited to, aggregation services 107A, storage services 107B, formatting services 107C, analysis services and alert notification services 107D.

The cloud platform 101 may be implemented as a private or a public cloud. A private cloud is typically hosted in an on-premises datacenter or in a datacenter of a managed service provider that provides access to the cloud computing services 107 via a private network to customers with appropriate authorization. Alternatively, a public cloud is typically hosted by a third party provider that provides access to the cloud computing services 107 via a public network, such as the Internet, to customers with appropriate authorization.

An Infrastructure as a Service (IaaS) model may be used to deliver the computing infrastructure of the cloud platform 101. IaaS abstracts hardware (server, storage, and network infrastructure) into a pool of computing, storage, and connectivity capabilities that are delivered as services. IaaS provides for a cloud system are built and run in the cloud, rather than in an on-premises datacenter and include virtual machines that are transparently connected to an on-premises network.

A Platform as a Service (PaaS) model may also be implemented on the cloud platform 101 for the execution of the cloud computing services 107 applications. PaaS delivers application execution services, such as application runtime, storage, and integration, for applications written for a pre-specified development framework within the cloud platform 101.

As such, any cloud based configuration known to one of ordinary skill in the art capable of delivering the computing services are envisioned as being encompassed with the present invention.

Returning to FIG. 1, the cloud computing services 107 include, but are not limited to, aggregation services 107A, storage services 107B, formatting services 107C, and analysis and alert notification services 107D.

The data aggregation service collects electronic health records from multiple electronic health record providers 102 that have been defined for each user of the mobile interoperable personal health information exchange with biometrics data analytics 100. The electronic health record providers 102 may include any facility that generates, manages, and stores patient medical and health records. The electronic health record providers 102 including, but not limited to, hospitals, outpatient clinics, health insurance agencies, physician practices, and prescription drug providers. The communication and interactions between the data aggregation service 107A and an electronic health record provider 102 is facilitated using any standard or proprietary transmission protocol, application programing interface (API), or software development kit specific to an electronic health record provider 102.

The data aggregation service 107A also collects electronic real-time biometric data transmitted from each of the mobile smartphone type devices and medical devices 103 belonging to users of the mobile interoperable personal health information exchange with biometrics data analytics 100.

Lastly, the data aggregation service 107A may also collect established clinical and laboratory indices from third parties, these indices relating to standardized biometric, laboratory value ranges medical norms across different age ranges, medical histories, geographic areas, or any other relevant physical, medical, or psychological references.

The data storage service 107B temporarily stores and provides temporary access to the electronic health records, and real-time biometric data collected by the data aggregation services 107A as well as an aggregated medical file generated by the formatting service 107C for each individual user. The data storage service 107B also permanently stores profiles for each user of the mobile interoperable personal health information exchange with biometrics data analytics 100 as well as collected statistical medical norm data.

The data formatting service 107C formats the temporarily stored electronic health records and real-time biometric data into a single comprehensive medical file. The electronic health records and real-time biometric data are parsed according to relevant topic headings and integrated into the comprehensive medical file under such topic headings. Additionally, the parsed data is appended with relevant meta-data as to enable efficient searching and analysis of the electronic health record and real-time biometric data integrated into the aggregated medical file.

The data analysis and alert notification service 107D analyzes the electronic health records and real-time biometric data integrated into the single aggregated medical file customized for each individual user in an attempt to identify possible medical trends and issues. Previously unknown possible medical trends and issues may be discernable from a comprehensive medical history originating from multiple electronic health record sources and various kinds of real-time biometric data that have been parsed, organized, and integrated into a single aggregated medical file. Additionally, the data analysis and alert notification service 107D may compare stored standardized medical norm statistical data to medical data within a comprehensive medical file to further aid in detecting possible medical trends and abnormalities. Lastly, the data analysis and alert notification 107D may notify a user or a defined physician of discovered medical trends or abnormalities.

The data analysis and alert notification service 107D uses predictive algorithms to recognize patterns in medical data to draw deductions from those patterns that may show the likelihood of particular health events occurring in the future. For optimal results in chronic disease management, predictive algorithms are applied to longitudinal data as provided by the single aggregated medical file. Using this type longitudinal health data that spans over time for a particular individual and analyzing this data with respect to age, gender, medications, and other relevant variables, patterns can be identified relating to possible health problems which that individual is presently encountering or may encounter in the future.

The identification of patterns relating to specific health problems is achieved through long term data mining and analysis of anonymous health data. This long term data mining and analysis of health data provides for the identification of abnormal biometric patterns, identify patterns of high risk populations for specific diseases, pattern classifications, trend analysis, and the prediction of future health trends.

In an exemplary embodiment, the identification of a possible abnormality begins with identifying a body part where the symptoms are located. Collected biometric and health records data specific to that body part are then compared against the collected established clinical and laboratory indices. Possible abnormalities are identified based on this comparison and defined thresholds.

Returning to FIG. 1, the electronic health record aggregation system 100 further includes a plurality of wearable biometric devices and medical devices 106 capable of short-range wireless communication with a smartphone type device 103 using any wireless communication protocol known to one of ordinary skill in the art including Bluetooth. Each wearable biometric and medical device 106 generates a specific type of real-time biometric data or medical data and wirelessly transmits that generated data to a mobile smartphone type device 103 to which it is coupled.

The type of data generated by the wearables biometric and medical devices 106 include, but is not limited to, blood pressure, pulse rate, respiratory rate, temperature, electrocardiogram (EKG), arterial oxygen saturation (SPO2), electroencephalogram (EEG), glucose, electromyography data, and stress level.

The mobile smartphone type devices 103 include a short-range wireless interface that provides for a smartphone type device 103 to wirelessly pair with a plurality of wearables and medical devices 106. Once a wearable biometric or medical device 106 has wirelessly paired with a smartphone type device 103, the smartphone type device 103 receives and stores data generated by each of the paired plurality of wearables biometric and medical devices 106. The smartphone type device 103 acts as a single point of collection and aggregation for all wireless streams of data originating from the plurality of wearables biometric and medical devices 106. At certain periodic intervals, the collection and aggregation real-time biometric and medical data is transmitted by the smartphone type device 103 to the cloud platform 101 where it is processed, analyzed, and temporarily stored.

The mobile device 101 may implement a mobile application that communicates directly with the cloud platform 101. The mobile application also collects, aggregates, and processes wireless streams of real-time biometric and medical data. The mobile application further provides access to a stored aggregated medical file and provides a graphical user interface which displays information contained within the stored aggregated medical file.

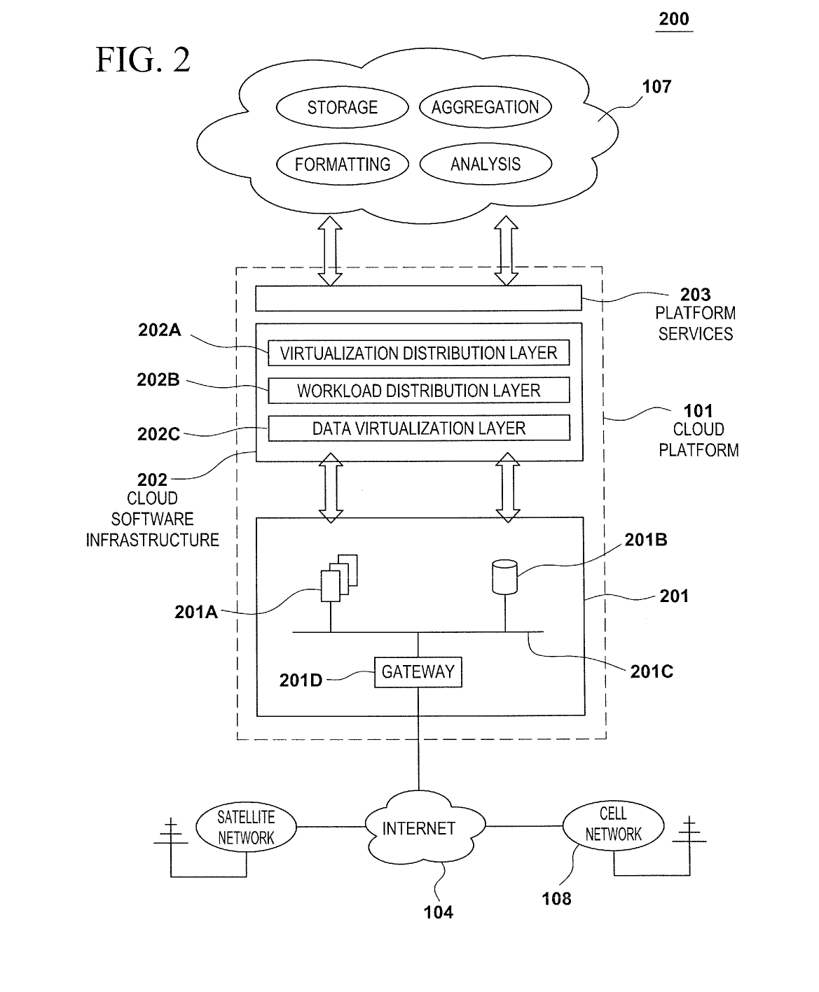

In FIG. 2, a block diagram of an exemplary cloud platform implementing the mobile interoperable personal health information exchange with biometrics data analytics is shown. As shown in FIG. 2, the exemplary cloud platform 101 includes a physical infrastructure component 201, a software infrastructure component 202, and a platform services component 203.

The cloud physical infrastructure component 201 includes distributed computational resources 201A, database storage 201B, and a gateway 201D, all of which are interconnected via an internal local area network 201C. The gateway 201D provides the cloud platform 101 access to a wide area network 104 such as the Internet, as well as cellular 108 and satellite networks 109.

The cloud software infrastructure component 202 includes a virtualization distribution layer 202A, a workload distribution layer 202B, and a data virtualization layer 202C. The cloud software infrastructure component 202 is implemented over the physical infrastructure component 201 and provides access to the hardware computing resources included within the physical infrastructure component 201.

The virtualization distribution layer 201A provides access to individual virtual machines which use the cumulative resources of the physical infrastructure component 201 and database storage 202.

The workload distribution layer 202B distributes, schedules, and manages process workloads implemented across the physical computational resources available within the physical infrastructure component 201.

The data virtualization layer 202C provides data management allowing an application to retrieve and manipulate data without requiring technical details about the data stored within the database storage 202, such as how data is formatted or where data is physically located.

The platform services component 203 provides cloud based access to the cloud computing services 107. In an exemplary configuration, the cloud computing services 107 are provided in a software as a service (SaaS) configuration.

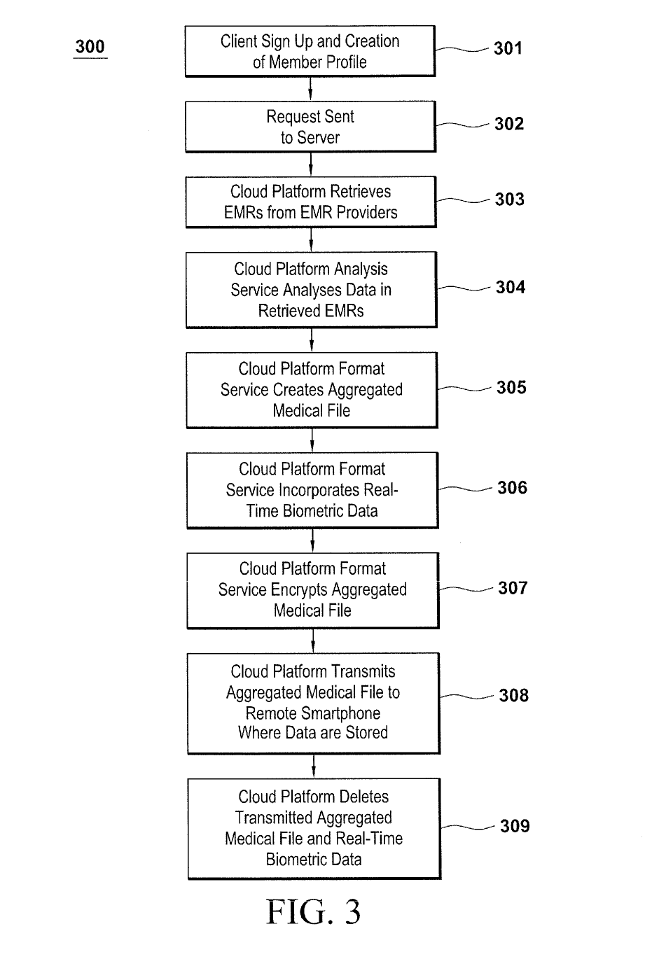

In FIG. 3, a flow diagram depicting a process implemented on the cloud platform of the mobile interoperable personal health information exchange with biometrics data analytics according to an exemplary embodiment is shown. As shown in FIG. 3, the process is initiated with a client electronically signing up with the system 200, creating a user profile that is permanently stored in the database 201B and downloading an application that is implemented on the mobile device 103. The client must provide relevant personal identification information, medical information, and electronic health record provider information.

The personal identification information may include the user's name, address, phone numbers, gender, date of birth, emergency contacts, or any other relevant information.

The personal medical information may include blood type, medications, allergies, upcoming medical appointments, emergency doctors contact information, authorized physicians, organ donor information, advance directives or any other relevant information.

The personal electronic health records information includes insurance providers and electronic health record providers including a URL for each of the medical record provider and authentication information giving access to the electronic health records provided by each of these providers.

The client's relevant personal identification information, relevant medical information, and electronic health record providers' information are populated into a client profile which is permanently stored in the database 201D.

Once the client profile has been created and stored and the application is implemented on the mobile device, the application in step 302 sends a request to the cloud platform to initiate the collection of the user's medical data.

Once a request has been received by the cloud platform, the aggregation service 107A in step 303 uses the information stored within the client profile to electronically communicate with each of the client's electronic health record providers and collect any available electronic health records for that client. The type of collected electronic health records may include those originating from hospitals, doctor offices, laboratories, or any other relevant sources. The topics covered by the collected electronic medical records may cover any medical or wellness subject matter including medical histories, laboratory results, X-rays, images and scans, prescription and over-the-counter medications, ECG/EKG monitoring information, inhaler use history, blood glucose readings, blood pressure readings, pulse oximeter readings, weight readings, sleep patterns, nutrition need and history, exercise and fitness activities, or any other relevant medical subject matter.

Once the client's electronic health records have been collected from the defined electronic health record providers, the analysis service 107D in step 304 processes the data within each of the collected electronic records and categorizes this data according to a defined set of topical modules. These topical modules include, but are not limited to, medical history, social history, OB/GYN history, family history, physical illnesses, diagnosis, laboratory test and results, plan of care, x-rays, images, scans, telemedicine data, organ donor information, and advanced directives information. Specifically, data relating to a specific module is identified and retrieved from each of the collected and stored electronic medical files and associated with that topical module. The topically categorized medical data and sub-categories are temporarily stored in memory on the cloud platform 101.

Once the medical data has been topically categorized, the formatting service 107C in step 305 creates a single aggregated medical file that is organized according to the topical modules and that includes all the categorized medical data under corresponding topical module headings. The storage service 107B temporarily stores the aggregated medical file in the database 201 while it is being populated and processed. Access to the aggregated medical file is restricted while it is stored in the database 201.

The format service 107C also adds meta-data to the aggregated medical file to further define the medical data included within the aggregated medical file. As an example, meta-data providing information identifying the origin of the data within the aggregated medical file as an electronic health record provided by a specific electronic health record provider is added. Other source identifiers may include wearable biometric devices, medical devices, radiological exams, and telemedicine consultations.

Once the aggregated medical file has been populated with electronic health records from selected electronic health record providers, the formatting service 107C in step 306 further integrates real-time biometric and medical data received from the application implemented in the client's smartphone type device 103. The application on the smartphone type device 103 having collected the real-time biometric and medical data from a plurality of wearables and medical devices 106 in communication with the smartphone type device 103.

Once the aggregated medical file has been created, formatted, and fully populated, the format service 107C in step 307 encrypts the temporarily stored aggregated medical file. In an exemplary embodiment, the aggregated medical file is generated as a HL7 compliant file. HL7 compliance provides a framework and standard for the exchange, integration, sharing, and retrieval of electronic health information. These standards define how information is packaged and communicated from one party to another, setting the language, structure and data types required for seamless integration between systems. HL7 standards support clinical practice and the management, delivery, and evaluation of health services, and are recognized as the most commonly used in the world. However, any other relevant file standard known to one of ordinary skill in the art may be used and are encompassed within the present invention.

Once the aggregated medical file has been encrypted, the system 200 in step 308 transmits the file to the smartphone type device 103 associated with the client.

Lastly, the storage service 107B in step 309 erases from the database both the aggregated medical file and the real-time biometric and medical data file as well as any other stored electronic medical files used to generate this file. The storage service 107C ensures that no collected electronic health records or real-time biometric and medical data are permanently stored on the database 201.

The process 300 returns to step 302 at predefined time periods to incorporate updated or additional medical information available from each of the defined electronic health record providers as well as newly received real-time biometric and medical device data from the client's smartphone type device 103.

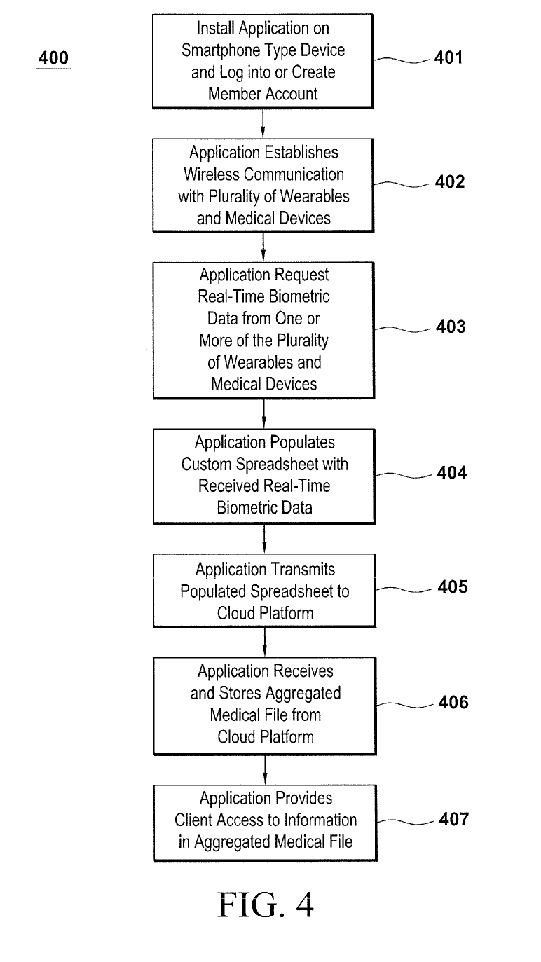

In FIG. 4, a flow diagram depicting a process implemented in a remote smartphone type device communicating with the mobile interoperable personal health information exchange with biometrics data analytics according to an exemplary embodiment is shown. As shown in FIG. 4, the process begins in step 401 with the installation of an application on the client's smartphone type device 103 and the client logging into an existing or newly created account on the cloud platform 101. If newly created, a graphical user interface displayed on the smartphone type device 103 queries the client for the information needed to create a user profile that is permanently stored in the database 201.

Once the application is installed and the client has logged into an account on the cloud platform, the application in step 402 establishes a short range wireless connection between the smartphone type device 103 and a plurality of wearables biometric and medical devices 106. As described above, the wearables biometric and medical devices 106 each collect and store specific real-time biometric and medical data about the client wearing or using the device.

Once a wireless connection between the smartphone device 103 and the wearable biometrics and medical devices 106 has been established, the application in step 403 requests, at designated time intervals, that each wearable biometric and medical device 106 transmit its stored real-time biometric and medical data to the smartphone type device 103.

Once real-time biometric and medical data from one or more wearable biometric or medical devices 106 has been received by the smartphone type device 103, the application in step 404 populates the received real-time biometric and medical data into a customized spreadsheet that is then stored on the smartphone type device 103. These spreadsheets are customized to address specific types of wearable biometric and medical devices 106 as well as specific wearable biometric and medical device 106 configurations. In addition, relevant meta-data is inserted into the stored real-time biometric and medical data. In an exemplary embodiment, as with the aggregated medical file generated in the cloud platform 101, these spreadsheet may be generated to be HL7 compliant.

Once the spreadsheet has been generated, populated, and stored on the smartphone type device 103, the application in step 405 transmits the populated spreadsheet to the cloud platform 101 for integration into a single aggregated medical file.

Once the transmitted real-time biometric data has been incorporated into an aggregated medical on the cloud platform 101, the application in step 406 receives and locally stores a new or updated version of the aggregated medical file transmitted from the cloud platform 101.

Lastly, the application on the smartphone type device 103 in step 407 accesses the locally stored aggregated medical file and displays the incorporate medical data in a manner that adhered to the topical modules comprising the file.

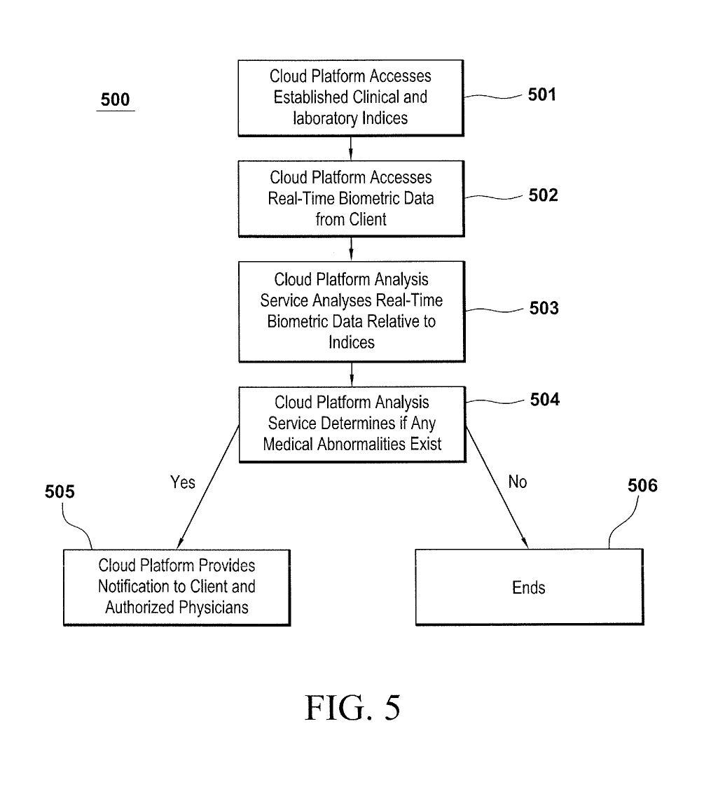

In FIG. 5, a flow diagram depicting the analysis of real-time biometric data on the cloud platform of the mobile interoperable personal health information exchange with biometrics data analytics according to an exemplary embodiment is shown. As shown in FIG. 5, the process begins in step 501 with the cloud platform 101 accesses and storing established standard clinical and laboratory indices in the database 201. These established standard clinical and laboratory indices may be acquired from third party sources including but not limited to the National Library of Medicine. These standardized indices provide a medical baseline against which a client's real-time biometric and medical data may be analyzed and compared.

Next, in step 502, the cloud platform 101 accesses a client's latest real-time biometric and medical data which has been received from the client's smartphone type device 103.

Once both the established standardized clinical and laboratory indices and the client's latest real-time biometric and medical data have been accessed, the analysis service 107D in step 503 determines if the client has any medical abnormalities by analyzing the real-time biometric data relative to the established standardized clinical and laboratory indices. The cloud platform 101 implements a predictive analysis that helps foreshadow possible abnormalities.

If it is determined that an abnormality exists, the cloud platform 101 in step 505 provides electronic notification to the client and to any physicians authorized to receive such notification as defined in the stored user profile.

If it is determined that an abnormality does not exist, the process ends in step 506.

The graphical user interface implemented by the application on the smartphone type device 103 may include an emergency button which results in an electronic notification being sent to one or more defined physicians, the electronic notification including global positioning system data of the client's present location.

The graphical user interface also provides for the display of radiological images and scans.

What is claimed is:

1. A mobile interoperable personal health information exchange with biometrics data analytics comprising:
a cloud platform implementing an aggregation service, a storage service, a formatting service and an analysis and alert notification service;
the aggregation service periodically collecting electronic health records from a plurality of third party medical record providers specific to an individual user;
the storage service temporarily storing in a database the collected electronic medical records for processing by the formatting and the analysis and alert notification services and subsequently erasing all non-anonymized medical records from the database without providing subsequent access all non-anonymized medical records;
the formatting service generating an aggregated medical file specific to the individual user comprising all the temporarily stored electronic medical records for that individual user; and
the analysis and alert notification service analyzing data included within the aggregated medical file to possibly identify health related abnormalities with the individual user.

2. The mobile interoperable personal health information exchange with biometrics data analytics of claim 1 wherein
the aggregation service further periodically collecting real-time biometric or medical data from a mobile device belonging to the individual user and in communication with the cloud platform;
the storage service temporarily storing in the database the collected real-time biometric or medical data;
the formatting service further including in the generated aggregated medical file specific to the individual the temporarily stored real-time biometric or medical data; and
the analysis and alert notification service further including in its analysis the real-time biometric or medical data included within the aggregated medical file to possibly identify abnormalities with the individual user and alerts them.

3. The mobile interoperable personal health information exchange with biometrics data analytics of claim 2 wherein the mobile device is in wireless communication with a plurality of wearable real-time biometric or medical devices that electronically paired with the mobile device;
the plurality of real-time biometric or medical devices generating real-time biometric or medical data on the individual user; and
the mobile device collecting real-time and medical data from each of the plurality of paired wearable real-time biometric or medical devices.

4. The mobile interoperable personal health information exchange with biometrics data analytics of claim 2 wherein the analysis and alert notification service implements predictive algorithms to recognize patterns in the medical data in the aggregated medical file to draw deductions from those patterns that may show the likelihood of particular health events occurring in the future.

5. The mobile interoperable personal health information exchange with biometrics data analytics of claim 4 wherein the predictive algorithms use longitudinal health data that spans over time for a particular individual and analyze this data with respect to age, gender, medications, and other relevant variables of the particular individual.

6. The mobile interoperable personal health information exchange with biometrics data analytics of claim 4 wherein the recognized pattern are established through
the analysis and alert notification service implementing long term data mining and analysis of anonymized health data providing for the identification of abnormal biometric patterns, patterns of high risk populations for specific diseases, pattern classifications, trend analysis, and prediction of future health trends; and
the storage service permanently storing in the database and providing access to the identified recognized patterns.

7. The mobile interoperable personal health information exchange with biometrics data analytics of claim 3 wherein real-time biometric and medical data generated by the paired wearable real-time biometric or medical devices may include blood pressure, pulse rate, respiratory rate, temperature, electrocardiogram (EKG), arterial oxygen saturation (SPO2), electroencephalogram (EEG), glucose, stress level and electromyography data.

8. The mobile interoperable personal health information exchange with biometrics data analytics of claim 3 wherein the mobile device aggregates the collected real-time biometric and medical data into one or more spreadsheets customized for the specific type of data collected from the paired wearable real-time biometric and medical devices and wirelessly transmits the spreadsheet to the cloud platform.

9. The mobile interoperable personal health information exchange with biometrics data analytics of claim 1 wherein the electronic medical record providers may include hospitals, outpatient clinics, health insurance agencies, physician practices, and prescription drug providers.

10. The mobile interoperable personal health information exchange with biometrics data analytics of claim 1 wherein the formatting service organizes the temporarily stored electronic medical records into the aggregated medical file according to defined topic headings reflecting specific types of medical and health data.

11. The mobile interoperable personal health information exchange with biometrics data analytics of claim 1 wherein the formatting service appends the generated aggregated medical file with meta-data that information on the data included with the aggregated medical file, this information including data source and data creation date and time.

12. The mobile interoperable personal health information exchange with biometrics data analytics of claim 2 wherein
the aggregation service further collecting standardized medical norm statistical data from third party providers;
the storage manager further permanently stores the collected standardized medical norm statistical data; and
the analysis and alert notification service comparing data in the collected real-time biometric or medical data and in the collected electronic health records for the individual user against the stored standardized medical norm data to possibly identify health related abnormalities with the individual user.
